(19) United States
(12) Patent Application Publication
(10) Pub. No.: US 2015/0196917 A1
(43) Pub. Date: Jul. 16, 2015

(54) METHODS AND APPARATUS FOR NUCLEIC ACID SYNTHESIS USING OLIGO-TEMPLATED POLYMERIZATION

(71) Applicant: THE BOARD OF TRUSTEES OF THE LELAND STANFORD JUNIOR UNIVERSITY, Palo Alto, CA (US)

(72) Inventors: Mark A. Kay, Los Altos, CA (US); Adi Barzel, Palo Alto, CA (US)

(73) Assignee: THE BOARD OF TRUSTEES OF THE LELAND STANFORD JUNIOR UNIVERSITY, Palo Alto, CA (US)

(21) Appl. No.: 14/605,538

(22) Filed: Jan. 26, 2015

Related U.S. Application Data
(63) Continuation of application No. PCT/US2013/027536, filed on Feb. 24, 2013.
(60) Provisional application No. 61/740,038, filed on Dec. 20, 2012.
(60) Provisional application No. 61/678,804, filed on Aug. 2, 2012.

(51) Int. Cl. B01L 7/00

(52) U.S. Cl. CPC B01L 7/525; B01L 2200/18

(57) ABSTRACT

A method and apparatus for synthesizing nucleic acid (NA) by sequential addition of nucleotide triphosphates to a single stranded NA molecule (growing-chain) is described. The growing-chain is annealed to an oligonucleotide, wherein the 3′ end of the oligonucleotide is complementary to the 3′ end of the growing-chain and wherein the protruding 5′ end of the oligonucleotide has the correct sequence to serve as a template for the growing-chain to produce a NA product. The growing-chain is then brought into contact with a polymerase in the presence of one or more nucleotide triphosphates under conditions permitting the polymerase to catalyze addition of one or more nucleotide triphosphates to the 3′ end of the growing-chain using the annealed oligonucleotide as a template. After polymerization has occurred, the annealed growing-chain and oligonucleotide are denatured so that the steps can be repeated until the NA product of desired length is synthesized.

### CROSS-REFERENCE TO RELATED APPLICATIONS

This application is a 35 U.S.C. §111(a) continuation of PCT international application number PCT/US2013/027536 filed on Feb. 24, 2013 and incorporated herein by reference in its entirety, which claims priority to, and the benefit of, U.S. provisional patent application Ser. No. 61/678,804 filed on Aug. 2, 2012 and incorporated herein by reference in its entirety, and which claims priority to, and the benefit of, U.S. provisional patent application Ser. No. 61/740,038 filed on Dec. 20, 2012 and incorporated herein by reference in its entirety. Priority is claimed to each of the foregoing applications.

The above-referenced PCT international application was published as PCT International Publication No. WO 2014/021938 on Feb. 6, 2014, which publication is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED IN A COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

The technology of this disclosure pertains generally to nucleic acid (NA) synthesis, and more particularly to de novo NA synthesis using Oligo-Templated Polymerization (OTP).

2. Background Discussion

Most of today's DNA vectors are built using a combination of pre-existing genetic building blocks, limiting our ability to manipulate cellular activity for research and therapeutics. The technology for de novo synthesis of desired DNA sequences has been advancing, but its cost and production time still prevent de novo synthesis from serving as a true alternative to recombinant DNA technology.

Present state of the art gene synthesis is costly because the current technology still relies on the production and assembly of multiple customized oligonucleotides (oligos) of 40-200 bases in length, which are then combined using ligation and/or PCR amplification. The customized oligos are synthesized chemically from phosphoramidite building blocks using cycles of coupling, capping, oxidation, and de-blocking.

Phosphoramidites are used because natural nucleotides are insufficiently reactive in a non-enzymatic setting. However, the use of highly reactive groups also leads to the occurrence of unwanted side-reactions. Protective groups are reversibly attached at multiple positions along the ribose and the base in order to reduce the chance of side reactions. However, errors still occur at a rate which sets the practical limit of oligo synthesis at no more than 200 bases. The cost of gene synthesis by current methods cannot go below the cost of customized oligonucleotide synthesis which is approximately $0.2 per base. Actual cost is in fact much higher because of the cumbersome oligo assembly step, which further dictates the prolonged production duration of approximately 1 week per 1 Kb.

Current oligonucleotide synthesis and assembly requires specialized equipment and training. Out-sourcing the production confers additional costs in time and money. Furthermore, current gene synthesis is sensitive to the high error rate and limited processivity of chemical oligo production, and therefore requires costly and time consuming quality controls and assembly steps. Thus, there remains a need for novel methods of DNA synthesis that are capable of producing DNA at the oligo, gene, and vector scales in a reliable, fast, simple, and cost effective manner.

### BRIEF SUMMARY

The technology described herein is based a new method and apparatus for synthesizing NA using oligonucleotides as templates for NA polymerization. This Oligo-Templated Polymerization (OTP) utilizes a comprehensive array of short oligos comprising all possible sequence permutations. At each cycle, a different oligo anneals to the 3′ end of a growing NA molecule, with the 5′ base of the oligo protruding and serving as template for subsequent polymerization. Either the oligo-array or the growing NA molecule is surface bound. Elongation is followed by denaturation, allowing for a new cycle to begin using the next-in-line oligo.

OTP has a minute error rate. Miniature oligos used in OTP have a much lower error rate than do the longer oligos used in current gene synthesis. The expected low error rate should have little effect on the OTP product as only a correct oligo and a correct growing NA molecule can anneal and allow for elongation. Importantly, the same oligo-array can be used for the synthesis of many desired sequences. Long NA molecules may be synthesized in a single continuous procedure. Indeed, OTP embodiments using liquid handling robotics have already underlined its superior processivity and accuracy.

### BRIEF DESCRIPTION OF THE SEVERAL VIEWS OF THE DRAWING(S)

The technology described herein will be more fully understood by reference to the following drawings which are for illustrative purposes only:

FIG. 1 is a schematic diagram of Oligo-Templated Polymerization (OTP) in accordance with the technology described herein.

FIG. 2 is a schematic diagram of manual OTP implementation.

FIG. 3A through FIG. 3D are schematic diagrams illustrating the four types of competing annealing.

FIG. 4A through FIG. 4D are schematic diagrams of automated OTP implementation according to one embodiment of the technology described herein.

FIG. 5A and FIG. 5B are schematic diagrams of two alternative systems for automated OTP.

FIG. 6 is a schematic diagram illustrating PCR amplification of intermediate OTP NA synthesis products.

FIG. 7A through FIG. 7D are schematic diagrams of OTP parallelization.

FIG. 8 is a flow diagram that illustrates a method of analyzing a NA to be synthesized and corresponding oligonucleotides to detect cycles that will be prone to the introduction of errors and reduced efficiency.

### DETAILED DESCRIPTION

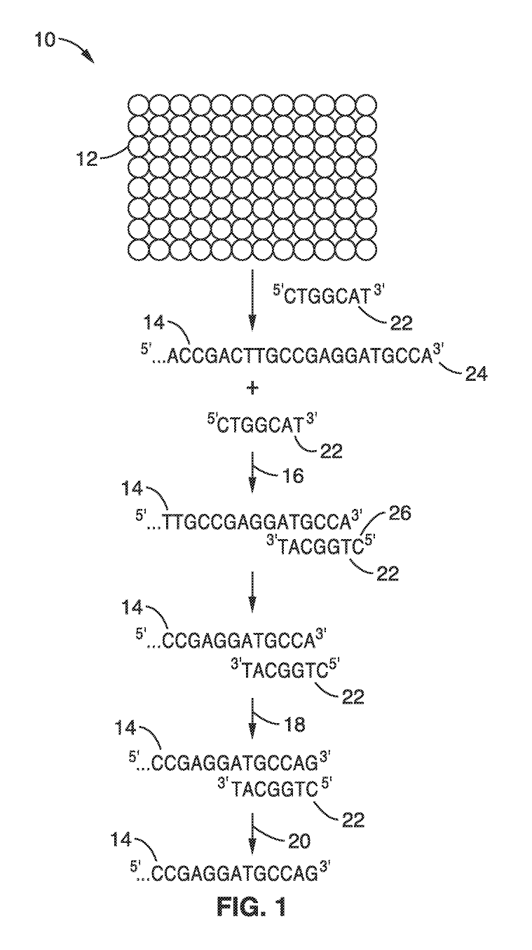

Referring more specifically to the drawings, for illustrative purposes several embodiments of the methods and apparatus for NA synthesis using OTP according to the technology described herein are depicted generally in FIG. 1 through FIG. 8. It will be appreciated that the methods may vary as to the specific steps and sequence and the apparatus may vary as to composition and structural details, without departing from the basic concepts as disclosed herein. The method steps are merely exemplary of the order that these steps may occur. The steps may occur in any order that is desired, such that it still performs the goals of the technology of this disclosure.

I. The OTP Process

FIG. 1 is a schematic flow diagram of an OTP method 10 in accordance with the technology described herein. OTP constitutes a fundamental paradigm shift in the field of gene synthesis. State of the art technology relies on the assembly of custom synthesized oligos. In contrast, OTP uses an off-the-shelf oligo-array 12 comprising all possible sequence permutations of a given length. The method comprises the sequential addition of nucleotides to a single stranded NA molecule (growing-chain) 14 using cycles of annealing 16, elongation 18 and denaturation 20. Each cycle uses a different oligo 22, chosen from the comprehensive array 12.

The oligo 22 anneals at the 3′ end 24 of a growing single stranded NA molecule 14. According to different embodiments of the technology described herein, either the oligos within the oligo-array or the growing single stranded NA molecule may be bound to a surface. The 5′ base of the oligo 26 protrudes and serves as a template for subsequent polymerization. It should be noted that although this illustration shows only one 5′ base protruding and acting as the template, it is possible to have a longer protrusion (more bases at the 5′ end serving as the template). Elongation 18 is made possible by providing a polymerase and either all types of nucleotides or the single desired nucleotide, for better specificity. If a 5′ end protrusion of more than 1 nucleotide is used, then a mix of all nucleotides must be used rather than a single kind. Denaturation 20 then follows and used reactants may be discarded by one or more washing steps to allow a new cycle to begin using the subsequent oligo.

Current gene synthesis is very sensitive to the high error-rate associated with the prerequisite chemical oligo production. OTP is also dependent on prior oligo-synthesis. However, the error-rate is considerably lower among short oligos used for OTP compared to the much longer oligos used in contemporary gene synthesis. More importantly, OTP is impervious to impurities in the oligo solutions, as only a properly-synthesized oligo can anneal and facilitate elongation. Similarly, a growing NA molecule that has not properly elongated at a given cycle will not anneal to oligos in subsequent cycles. Optionally, sequences synthesized using OTP can be PCR amplified using primers that are specific to synthesized ends. The high specificity of OTP obviates the need for excessive and costly quality controls used in current NA sequence assembly techniques.

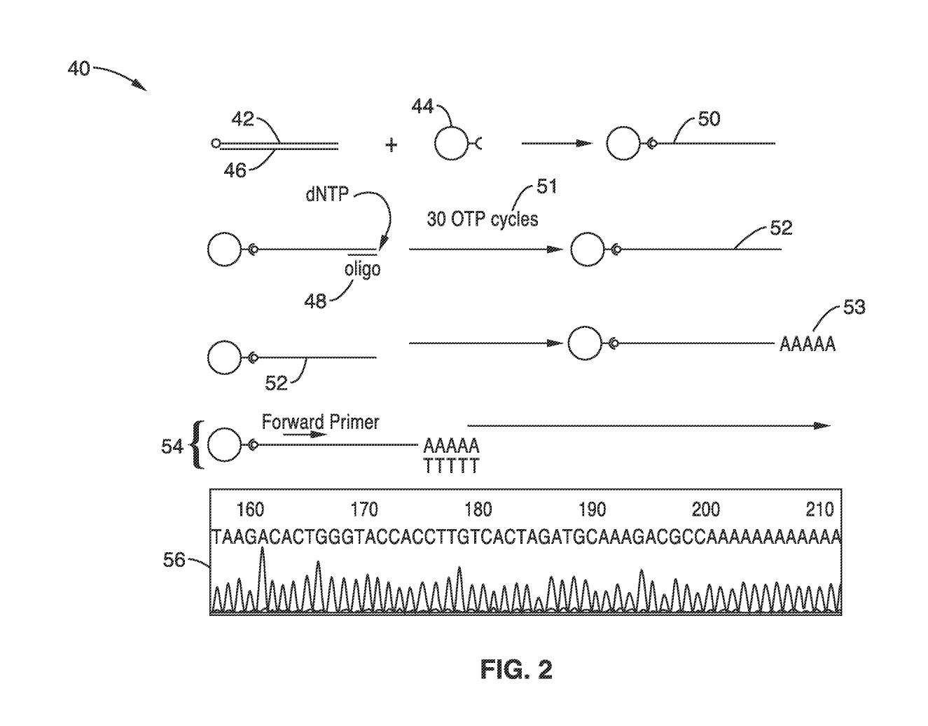

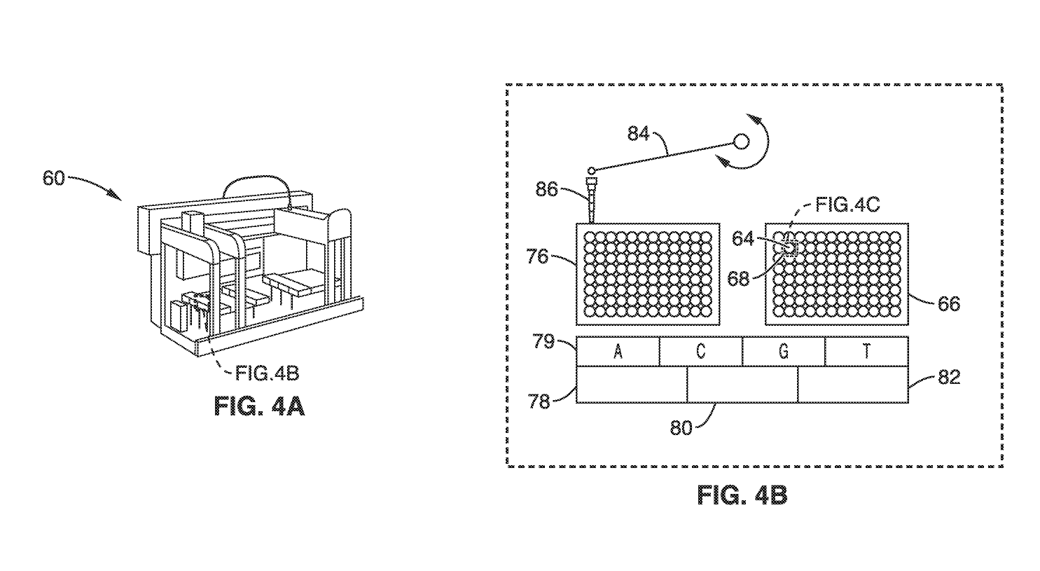

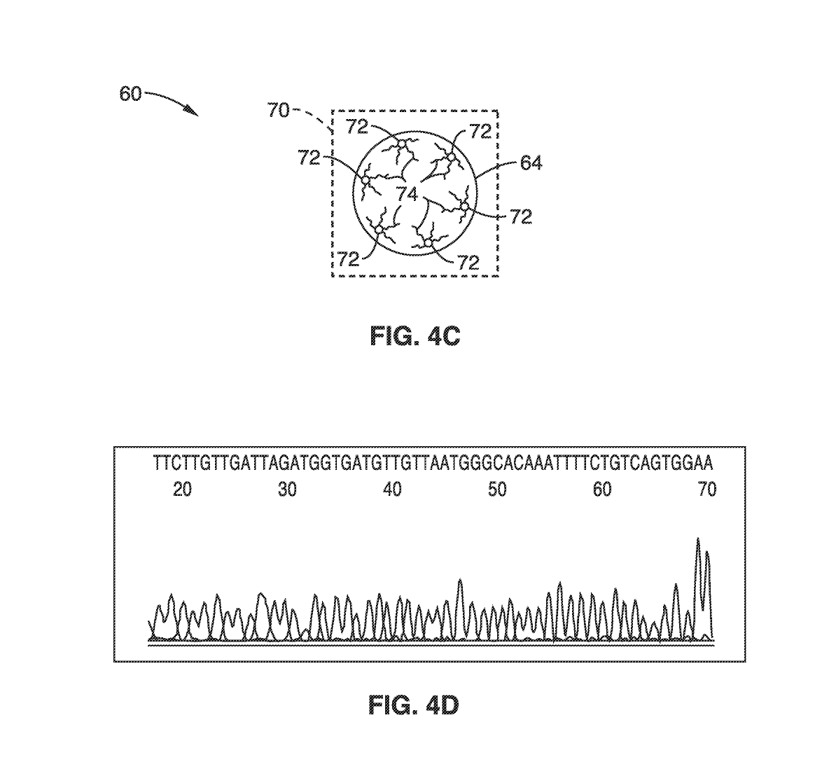

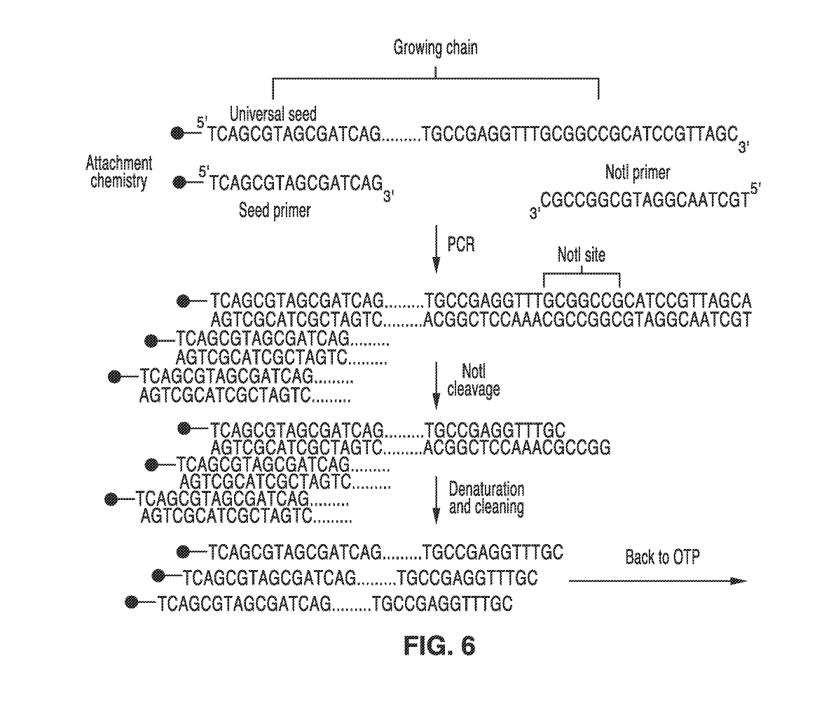

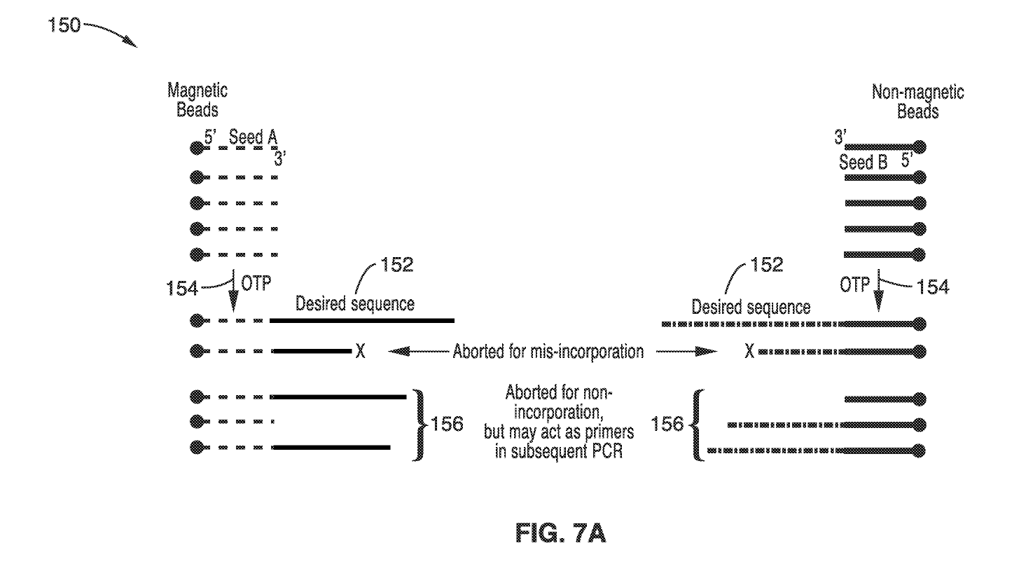

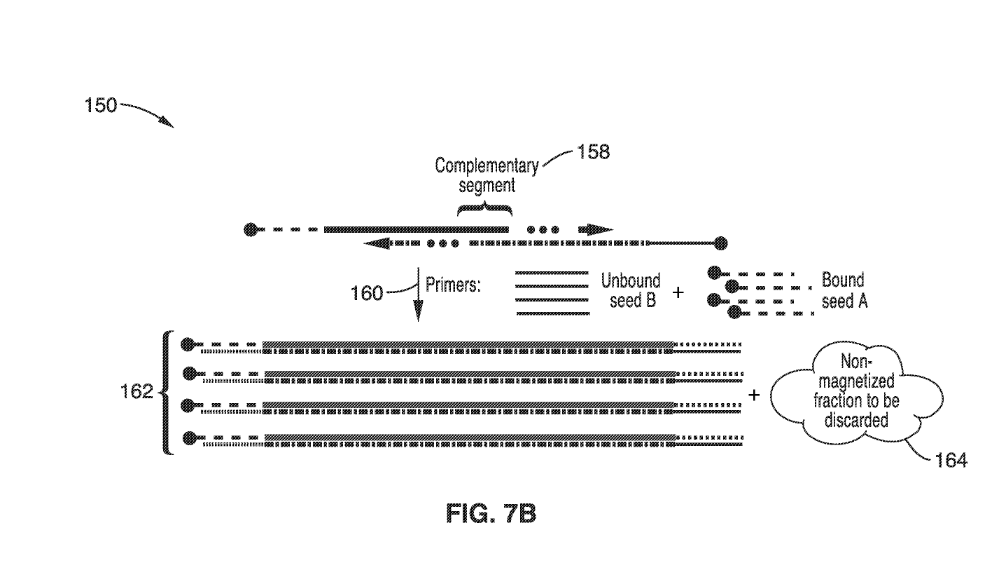

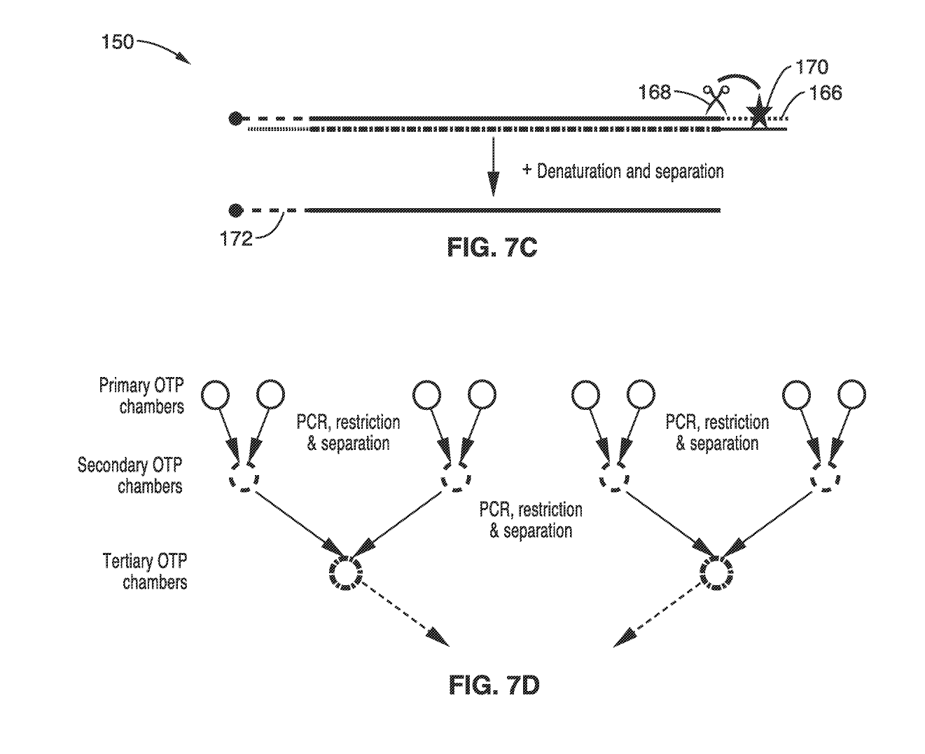

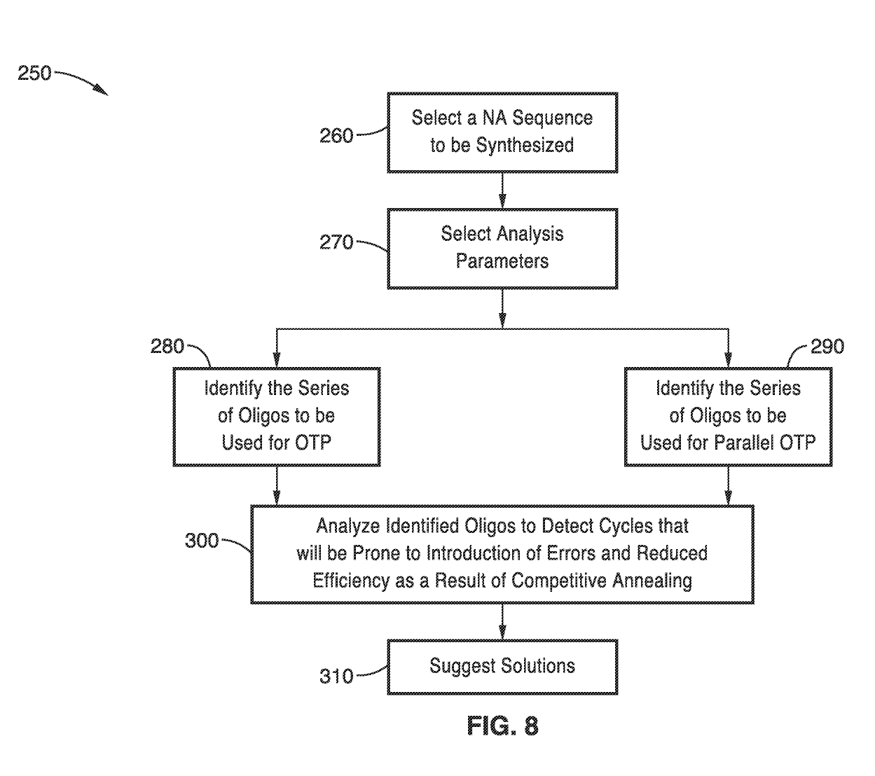

The efficiency and specificity of OTP rely on a multitude of biochemical parameters including: attachment chemistry, oligo length and composition, reagent concentrations, temperatures and durations of the iterative steps. A set of conditions was found that allowed us to manually synthesize a sequence of 30 nucleotides (FIG. 2). We were also able to synthesize a sequence of 96 nucleotides using the BioMek FX liquid handling robot (FIG. 4A through FIG. 4C). Reliable synthesis of much longer sequences may require either one or a combination of: (1) A prudent adjustment of the biochemical variables, (2) PCR amplification of intermediate products (see FIG. 6), or (3) Parallel OTP of partially complementary segments followed by PCR assembly (see FIG. 7). This is particularly true because OTP efficiency decreases exponentially with every cycle. For example, if each cycle is 99% efficient, then synthesizing a sequence 1 Kb in length would only be 0.99^{1,000}˜0.00004 or 0.004% efficient, which may be too low even if the final sequence was subsequently PCR amplified. As the entire parameter space cannot be surveyed, our approach combines rational inference with experimentation at carefully sampled sets of conditions. The yield and accuracy associated with different choices of parameters can be assessed by Quantitative Polymerase Chain Reaction (QPCR) and deep sequencing, respectively. In addition, yield and accuracy associated with different choices of parameters can be analyzed prior to synthesis (see FIG. 8).

II. Manual OTP Implementation

FIG. 2 shows a schematic diagram of one embodiment of the OTP method and apparatus, 40 wherein the steps of OTP were performed manually. First, a semi-biotinylated PCR product 42 was bound to streptavidin coated magnetic beads 44, which were held in place at the bottom of a 1.5 ml Eppendorf tube (not shown). The non-biotinylated strand 46 was discarded. Oligos with a length of 11 nucleotides 48 were used as the oligo templates and annealed to the surface-bound growing single stranded DNA molecule 50. The oligo solution was added to the beads at a concentration of 100 μM.

Next, elongation was performed using Klenow DNA polymerase at a concentration of 1 unit per cycle, the units defined according to manufacturer's instructions. Annealing and elongation steps were each carried out jointly for 2 minutes at 25° C. The reaction was heated using an Eppendorf thermo regulated block. Denaturation steps were carried out for 1 minute using 0.1 M NaOH at room temperature. The 30 base sequence was OTP synthesized at a rate of 1 nucleotide per cycle for 30 cycles 51. The sequence product 52 was poly-adenylated 53 to allow PCR amplification 54 and sequencing 56. No gel extraction or cloning was required.

III. Optimization of the Biochemical Parameters of OTP

A. Bead Selection and Attachment Chemistry

OTP comprises multiple rounds of annealing and denaturation that require temperature shifts or PH changes. OTP may further entail excessive pipetting, subjecting the NA to shearing forces. In OTP embodiments wherein the growing single stranded NA molecule is surface-bound, the attachment chemistry is additively challenged in every cycle. Therefore, the attachment of the growing NA molecule to the beads must be extremely resilient. Conversely, in embodiments wherein the oligos are surface-bound to a compartmentalized array (i.e. the wells of a 96-well plate), the attachment chemistry may be challenged in a different chamber for each cycle. Still, multiple uses of the same array require stringent attachment. Moreover, strong binding of the oligos to the solid phase reduces cross-contamination.

We had initially used Streptavidinylated magnetic beads and biotinylated DNA (see FIG. 2), but have switched to using dual-biotinylated growing single stranded DNA molecules for longer syntheses (see FIG. 4A through FIG. 4C). However, there are several alternative covalent chemistries, including Alkyne-Azide and Amine-NHS, that can be used. Different surfaces with varying attachment methods may have a different loading capacity as well as a different sensitivity to subsequent challenges of temperature, PH and shearing forces. These can be assessed by QPCR independently of OTP. However, a higher binding capacity does not necessarily produce better OTP propensity, as binding that is too dense may confer steric interference. Additionally, using beads of a smaller diameter should increase the surface/volume ratio and reduce pipetting-induced shearing forces. However, if vacuum is used for bead separation, the diameter must be larger than the pore-size of the filter.

B. Oligo Composition and Length

The oligos used in OTP are arranged in a comprehensive array of oligo-solutions, such that any possible oligo of a pre-determined length is represented in exactly one solution and all the oligos in any given solution share a common 5′ end. A simple example would be an array of 4⁷=16,384 solutions, each containing a different, single kind of heptamer. Alternatively, multiple different oligos may be combined into joint chambers according to some pre-specified rule. Additionally, oligos may include modified bases to increase binding strength and specificity (e.g. locked nucleic acids (LNA)), and universal nucleotides, which promiscuously bind to all four standard bases. In OTP embodiments where oligos are surface-bound, their 3′ end must be blocked because oligo elongation may preclude it from subsequent use. Finally, in the very special but interesting case of Xeno Nucleic Acid (XNA) synthesis, the oligos may further include XNA nucleotides (e.g. diaminopyrimidine and xanthine).

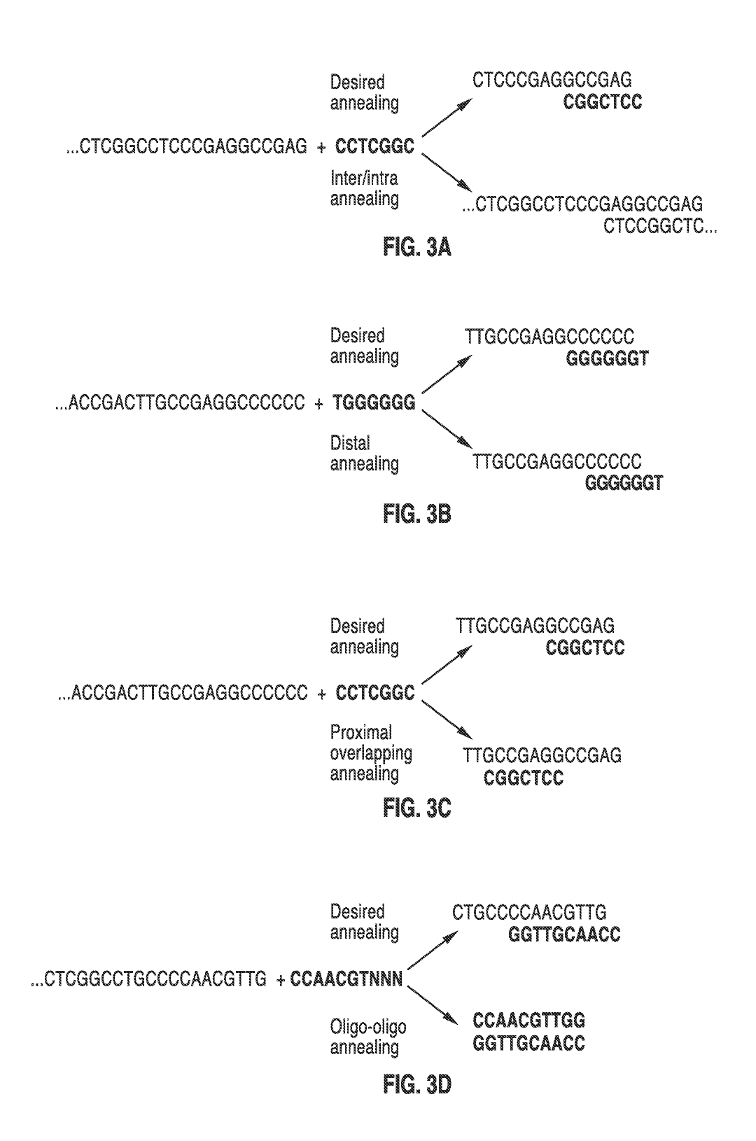

Oligo length is an important factor to consider for successful OTP. Longer oligos anneal to the growing single stranded NA molecules with better affinity and better specificity. Moreover, longer alignment of the oligo to the growing NA molecule allows for better docking of the NA polymerase for the subsequent elongation step. Longer oligos also allow for the use of higher temperatures at the annealing and elongation steps, thus reducing the chance of intra and inter-annealing of the growing single stranded NA molecules (see FIG. 3A).

The oligo-array must also include each possible permutation of a given length to allow synthesis of arbitrary NA sequences. Therefore, using oligos with one additional specified nucleotide necessitates using four times as many oligos. Synthesizing more oligos and longer oligos directly affects the cost of the preliminary oligo-synthesis step. However, this may have a modest effect on final pricing because the same oligo-array can be used many times for the production of many desired NA sequences. Furthermore, the production of plural oligos differing only in a pre-specified position is made much cheaper by using phosphoramidite mixtures (“N”) during the appropriate step of oligo-synthesis. For example, a given OTP array may require 4⁴=256 disjoint nonamer solutions, one of which could be abbreviated as CTTGNNNNN. In other words, each solution would include 4⁵=1,024 nonamers with a constant 5′ tetramer and a randomized 3′ pentamer. Notably, the incorporation rate of the four phosphoramidites during oligo-synthesis is non-uniform and may have to be compensated for by a complementary bias in their mixing, in order to obtain equimolar oligo solutions.

While the pricing of oligo-synthesis may not be the limiting factor, increasing the total number of oligos may have additional consequences. Specifically, quadrupling the number of oligos compels quadrupling the product of the size of the array, its density and the number of oligos within each chamber. Increasing the size or density of the array directly affects the practicality and affordability of the OTP system. However, increasing the number of oligos in each solution affects the efficiency and specificity of OTP in subtle ways which are also important. This is because, given a constant volume and maximal concentration, having a larger number of different oligos in each solution means having a lower concentration of each individual oligo. Additionally, having a plurality of oligos at each cycle increases the chance of a competing annealing that may introduce errors or reduce efficiency.

FIG. 3A through FIG. 3D are schematic diagrams illustrating the four types of competing annealing. Intra and inter annealing of the growing single stranded NA molecules, shown in FIG. 3A, can be avoided by using oligos at least 10 bases long and discriminative annealing temperatures. For example, there is a >99.5% chance that a 5 Kb long sequence will include no two perfectly-complementary decamers. Rare incidences of such complementarity should have little effect if oligo molarity far exceeds that of the growing single stranded NA molecules. This, however, will only be true if the desired oligo has a high enough proportion within the solution. Finally, the low chance of inter and intra annealing of the growing chain can be reduced further by parallel OTP synthesis of partially complementary short segments followed by PCR assembly (FIG. 7).

Distal overlapping annealing, shown in FIG. 3B, is rare. It is only possible when all consecutively specified positions are identical at the 5′ end of the oligos in a given solution, except perhaps the very 5′ nucleotide, e.g. TGGGGGGNNN. If the 5′ end of the oligo is a complete homopolymer, then distal annealing can introduce lingering mistakes. However, distal annealing has a lower melting temperature (Tm) than does the desired annealing and hence can be avoided simply by using a discriminative annealing temperature. Additionally, the oligo array may include a few additional longer oligos to bridge over homopolymeric repeats.

When the oligos are dissolved, proximal annealing is only a problem when it overlaps with the desired annealing, as shown in FIG. 3C. While it cannot introduce errors, such as overlap can, it does reduce OTP efficiency, especially when proximal annealing has higher affinity than the desired alignment. This occurs when the overlapping annealing includes the 5′ nucleotide of the oligo. It can be avoided by using a 5′ universal nucleotide which cannot contribute to the strength of annealing. If a 5′ universal nucleotide is indeed used, then elongation solutions must include only the desired nucleotide and not a dNTP mix. Importantly, the rate of proximal overlapping annealing is negatively correlated with the number of specified positions. It is possible to overcome this challenge by pre-annealing with a different oligo that binds even more proximally in a way that competes with the original competitor but not with the desired annealing. Notably, when oligos are surface-bound, proximal annealing may compete sterically with the desired annealing, even when non-overlapping, oligo-oligo annealing (FIG. 3D) competes with the desired annealing between the oligo and the growing NA molecule.

The rate of oligo-oligo annealing, shown in FIG. 3D, is also negatively correlated with the number of specified positions. Using oligos of an odd length, with the middle position being specified, abolishes the risk of full oligo-oligo annealing (because no nucleotide is complementary to itself). Using universal nucleotides at internal positions confers a disadvantage to oligo-oligo annealings, as these will cause more pairings, including a universal nucleotide than will the desired annealing. Pairings including a universal nucleotide do not contribute to the affinity. Conversely, the use of LNAs will confer an advantage to oligo-oligo annealings over the desired annealing and therefore, LNAs should only be used when such competing annealings are impossible.

All types of competing annealing can be overcome by using a long custom oligo. The user may load the long custom oligo into an empty chamber of the oligo array. This long oligo should serve to bridge over the challenging segment. The bridging oligo should be long enough, and the annealing temperature high enough, to ensure unique alignment. Importantly, the synthesis of most constructs should not require such custom oligos. Competing annealing is rare and the associated yield reduction is often non-detrimental because: (1) the final product is PCR amplified, (2) PCR of intermediate products can be integrated as part of the automation (see FIG. 6), and (3) short partially complementary segments can be synthesized by OTP in parallel followed by PCR assembly (see FIG. 7).

According to one embodiment of the technology described herein, oligos with lengths ranging from ten to twelve bases are used, and five to seven bases are specified at the 5′ end. Universal bases are included in the 5′ position and the penultimate 3′ position of each oligo. The molarity of growing NA molecules can be very high when using oligos as the seed sequence (unlike the PCR products used in FIG. 2 and FIG. 4A through FIG. 4C). Therefore, the concentration of oligo at each cycle becomes the limiting factor. The desired oligo is used at a concentration of no less than 1 μM, so that a solution of 1,024 different oligos will have a concentration of ˜1 mM. Annealing is performed on a thermo-regulated platform in order to out-compete undesired alignments.

C. Polymerase Choice and Elongation Conditions

OTP was performed with the large Klenow fragment of the E. coli NA polymerase I. The large Klenow fragment retains 3′→5′ exonuclease activity but lacks a 5′→3′ exonuclease activity as well as a terminal deoxynucleotidyl transferase activity. Thus, it insures precise elongation at each OTP cycle. The Klenow fragment is also highly active in temperatures between 200° C. and 400° C., allowing the user to choose an elongation temperature that will not cause detachment of the short oligos used in OTP.

Some OTP embodiments have the polymerase and NTs in the same solution as the growing-chain. In these instances, the solution may be transferred between the chambers of a solid-phase oligo-array, substantially reducing the waste of polymerase and NTs. In these applications, the user is restricted to using a NT mix rather than a single kind of NT per cycle.

Conversely, if the growing-chain is surface-bound, polymerase waste can be reduced by attaching the enzyme to the same solid-phase as the growing-chain. Additionally, in embodiments with bound growing-chains, there is a non-trivial choice of whether to use a single NT kind at each elongation step or to use all NTs. On the one hand, using only the NT that has to be added should reduce the error rate. It should also allow for the use of a universal nucleotide at the 5′ end of each oligo, which reduces the chance of a competing proximal annealing. On the other hand, using all NTs allows the oligo used as a template to also moonlight as a primer. This is advantageous because it should extend the annealing tract and stabilize it, thus promoting productive polymerase docking and synthesis. This benefit is not available in oligo-bound embodiments, where a NT mix will be used but the oligos will have their 3′ end blocked.

D. Denaturation and Cleaning Conditions

In general, denaturation and cleaning conditions should be chosen to allow for efficient detachment of the growing single stranded NA molecules from the oligos while having minimal adverse effect on the attachment of the growing single stranded NA molecules to the beads. Heat denaturation is possible but problematic as it may require the use of a thermostable NA polymerase. These enzymes are often active only at high temperatures; so high in fact that they may cause detachment of the oligo prior to the desired elongation. The currently used alkali denaturation is assumed to be less antagonizing to the biotin-streptavidin bonding than is high temperature. However, different denaturation and cleaning techniques may have to be used for different attachment chemistries.

In OTP embodiments using fixed oligos and dissolved growing single stranded NA molecules, an alkali solution may be added at each elongation step followed by a PH buffer addition at the subsequent annealing step. Importantly, volumes added must be minute in order to avoid over-diluting the growing single stranded NA molecules and NA polymerase.

For each parameter-set, efficiency and specificity can be assayed using QPCR and deep sequencing. In particular, the yield and accuracy of synthesizing the first 96 bases of GFP can be assessed under different conditions. Samples produced at the conditions of FIG. 2 can serve as a reference in QPCR and deep sequencing assays. As different embodiments may have the growing-chain in solution or alternatively bound to various beads, the unit loaded into a QPCR reaction is defined in terms of proportion of the substrate, rather than in moles or in grams. Specifically, each QPCR reaction will be loaded with 10% of the volume of the growing NA molecule's solution or with 10% of the beads. Illumina sequencing is sensitive but costly. Therefore, a library can be prepared for sequencing once every 5 OTP runs, using differential bar-codes. Additional sequencing schemes may be used for longer reads, albeit with much reduced sensitivity, including SMRT technology or bacterial cloning followed by multiple Sanger sequencing.

In one embodiment of the technology described herein, the Green Fluorescent Protein GFP open reading frame can be synthesized in 1.5 minutes per cycle and an error-rate of less than 1 in a Million. Fine tuning may allow the synthesis of much longer molecules, but this may also require determining the best automation scheme for OTP as detailed below.

IV. Automated OTP Implementation

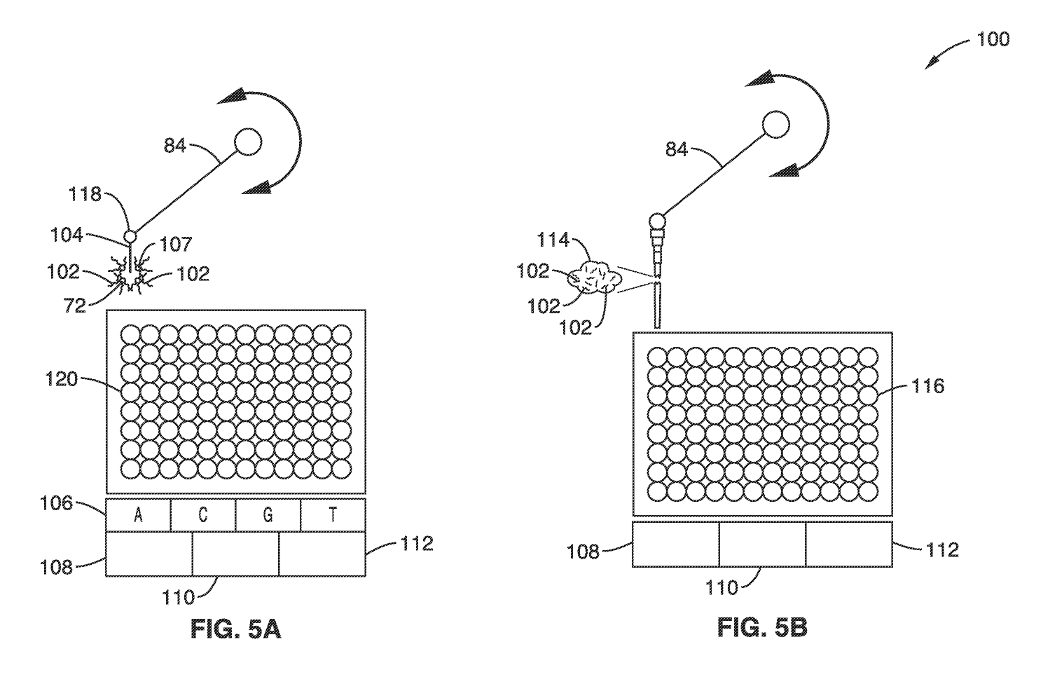

Robotic OTP designs can be broken down into three fundamental categories according to the choice of the solid-phase component (FIG. 4A through FIG. 5B). The decision to have the growing-chains bound to a reaction chamber (FIG. 4B), or bound to the moving arm (FIG. 5A) or alternatively to have the oligo array in the solid phase (FIG. 5B) carries multiple implications.

Initial automated embodiments followed the scheme presented in FIG. 4A through FIG. 4D. FIG. 4A through FIG. 4C are schematic diagrams of the OTP method and apparatus, 60 wherein the steps of OTP were performed using the BioMek FX liquid handling robot shown in FIG. 4A. Referring now to the platform of the BioMek FX liquid handling robot (FIG. 4A) shown in detail in FIG. 4B, a reaction chamber 64 was prepared by surrounding a well within a 96-well plate 66 with small magnets 68. A magnified schematic diagram of the reaction chamber 70 is also shown in FIG. 4C. Streptavidinylated magnetic beads 72 that were coated with dual-biotinylated growing single stranded DNA molecules 74 were then added to the magnetized reaction chamber 64.

The 96-well plate 66, including the reaction chamber, 64 was then placed in a BioMek FX liquid handling robot 62. A 96-well plate 76 containing an oligo-array and elongation solution, including DNA polymerase and the four dNTPs was also placed in the same BioMek FX liquid handling robot 62 which contained three reservoirs holding denaturation solution 78, neutralization buffer 80 and cleaning buffer 82. Alternatively, the elongation solution may comprise a mixture of the four dNTPs or the dNTPs may be kept in four separate reservoirs 79. Also, the elongation solution, including a DNA polymerase and one or four dNTPs, can be stored and transferred with the oligos (as was done in the embodiment shown here in FIG. 4A through FIG. 4C) or transferred from a separate chamber. A moving arm 84 carrying a robotic pipette 86 transferred solutions into and out of the reaction chamber 64 for 96 cycles of annealing and elongation (2 min at 21° C. for each cycle), denaturation (0.1M NaOH for 1 min), neutralization (1×TE, 66 Mm citric acid) and cleaning (NEB buffer 2). The product sequence comprising 96 nucleotides was PCR amplified and sequenced, as shown in FIG. 4D.

This embodiment minimizes the risk of cross-contamination, as each oligo-chamber is only contacted with fresh pipette tips. Pipette tip waste can be mitigated by using washable tips, however, this design is inherently wasteful in oligos and dNTPs. Most importantly, the design is uneconomical in its use of DNA polymerase. The enzyme can be reused if it is bound to the reaction chamber via a linker. However, the enzyme and attachment chemistry must both withstand multiple denaturation steps and shearing forces.

One aspect of the embodiment described in FIG. 4A through FIG. 4C is the constant magnetization of the beads in the reaction chamber, allowing only a fraction of the growing DNA molecules to interact with the oligos and the elongation solutions. To solve this problem, the beads can be automatically taken out of and put into the solution. This can be achieved in three different ways. In the first embodiment, the reaction chamber and the magnet can be physically disassociated and associated using the gripper function of the Biomek along with geometrically compatible reaction chamber and magnet, e.g. a well and a ring respectively. In a second embodiment, a controllable electro-magnet is used to disassociate and associate the reaction chamber and the magnet. In a third embodiment, a filter-bottom well is used as a reaction chamber, allowing for bead separation using a vacuum manifold. Using an electromagnet or filtration should obviate the use of a gripper and reduce cycle times.

Thermoregulation of the reaction chamber can be used in order to optimize annealing and elongation. However, thermoregulation of a filter plate or an electromagnetic labware is less straightforward. Whichever way is chosen to allow the beads to enter and exit the solution, it might come with the price of subjecting the growing DNA molecule to excessive shearing forces that are associated with multiple pipetting. This concern can be mitigated by using wide-bore tips and slow pipetting.

V. Alternative OTP Designs

FIG. 5A and FIG. 5B show two alternative automated OTP embodiments 100. FIG. 5A is a schematic diagram of one embodiment of the technology described herein, wherein the growing-chains 102 are associated with the moving arm 84. In this embodiment, the Biomek arm is fitted with a magnetic needle 104, at the distal end of the robotic arm 118 which is linked to magnetic beads 72 covered with the growing-chains 102 via an appropriate attachment chemistry (see Section III.A.). The needle 104 is a controllable electromagnet, which allows the beads to enter and exit the solution. This embodiment will waste less polymerase, oligos, and NTs compared with the previous design, albeit some reactant loss is to be expected upon exiting each chamber. The growing-chains 102 are brought to interact with an oligo solution 120 for annealing and then with an elongation solution 106, if the two solutions are stored separately. The growing-chains 102 would also optionally be brought to interact with the denaturation solution 108, the neutralization solution 110 and the cleaning solution 112 (if heat was not used to denature the NA-oligo complex). It should be noted that denaturation and cleaning conditions must be stringent in order to preclude cross-contamination. It is possible that synthesizing NA on the needle will reduce the shearing forces associated with multiple pipetting. However, only experimentations could verify that dipping and extracting is indeed superior to pipetting in this context. Importantly, the Biomek is a liquid handling robot, and hence some of its finest features are not best-suited for the manipulations of an electromagnetic needle. Therefore, final optimization of this embodiment may only be possible through custom robotics.

In another embodiment of the technology described herein, shown in FIG. 5B, the growing-chains 102 are in solution 114 along with the NA polymerase and four dNTPs. The growing single stranded NA molecules 102 are transferred in every cycle to a different chamber (i.e. the well of a 96-well plate or well within an array comprising thousands of different oligonucleotides) of a compartmentalized solid-phase oligo-array 116 for the purpose of annealing and elongation. In this embodiment, the oligos are attached to the array substrate using appropriate attachment chemistry.

Having the oligos associated with the solid-phase may confer several benefits over the aforementioned designs. First, the attachment chemistry between the oligo and the solid phase is challenged by the denaturation conditions in a different chamber for each cycle. Thus, there should be much less loss of bound-NA. This particular embodiment should also be highly economical in NA polymerase and dNTP use as these are not aliquoted and discarded in each cycle, but instead are retained within the same solution as the growing NA molecule. Using a solid-phase oligo-array also avoids some technical challenges associated with an array of solutions, such as storing, shipping, spilling, and evaporation. It may even allow for performing OTP in lower volumes, occupying less bench space.

It should be noted that this embodiment requires the use of all four dNTPs in each elongation step, diminishing the reduction in error-rate that is associated with the use of only one desired dNTP per cycle. In other embodiments, this loss is alleviated by the oligo moonlighting as a primer, thus extending the annealing tract, allowing better polymerase docking, and possibly promoting productive polymerization. However, this is not the case when oligos are surface-bound, as their 3′ end must be blocked if they are to be re-used in subsequent syntheses.

Efficiency of elongation may be compromised by competing proximal annealings, even when these are non-overlapping, because of steric interference. Denaturation is also challenging. If heat is applied then a thermostable polymerase must be used. Such polymerase is often active only in temperatures that preclude annealing of the short oligos used in OTP. Conversely, using alkali denaturation requires the addition of a base at the end of each cycle and a PH buffer at the beginning of the subsequent cycle. Miniscule volumes must be used to avoid diluting and losing DNA, enzyme, and nucleotides.

In all embodiments of the technology described herein, heat denaturation is possible. If alkali denaturation is used, the system may include chambers for denaturation 108 and neutralization 110 solutions along with a chamber for cleaning solution 112. Also, in all designs, the NA polymerase may be associated with the solid phase via a linker (not shown).

All of the embodiments described herein may further comprise PCR chambers for the amplification of intermediate OTP products (see FIG. 6) and/or for the PCR assembly of partially complementary segments following parallel OTP (FIG. 7A through FIG. 7D). PCR amplifications can compensate for the exponential reduction in OTP efficiency as a function of length. It can also compensate for diminished yield resulting from competing annealing (see FIG. 3A through FIG. 3D). Amplifications can be used periodically (e.g. once every 500 bases) or immediately after a challenge. Importantly, the PCR reactions can use off-the-shelf primers that can be provided with the OTP system and oligo-array.

Turning now to FIG. 6, the growing single stranded NA molecule serving as a template is either dissolved or bound to beads depending on the OTP embodiment. If, for example, no NotI sites are present in the desired sequence, then PCR amplification of intermediate products can be performed whenever a GC dinucleotide is synthesized. First, a short segment is synthesized ad hoc to serve as a primer binding site. PCR follows using a seed primer with a 5′ end attachment modification and a second primer coding the NotI recognition site at its 3′ end (NotI primer). Amplification is followed by NotI cleavage, denaturation, and cleaning. Thus, the amplified growing NA molecule is reconstituted for continued OTP. Several alternative enzymes and respective primers can be used with the OTP system and oligo-array.

One primer should correspond to the seed region of the growing chain, which may be universal. The universal seed can be excluded in the amplification of the final product, which is the only amplification that would require custom primers. In the amplification of intermediate products, the seed primer should be surface-bound to allow recovery of the growing chain by denaturation after amplification. If the attachment chemistry is thermolabile, binding can be subsequent to the amplification. In the embodiment described in FIG. 5B, the attachment chemistry should be reversible to allow dissolution of the growing chain. The second primer will anneal to a NA segment to be synthesized ad-hoc and cleaved after the amplification. In order for the primer-binding-site to be cleaved off after amplification, it must include a recognition-site for a restriction endonuclease, the site being unique in the synthesized construct. This is accomplished by providing several complementary sets of endonucleases and primers. The enzymes should have an 8 bases long recognition site and leave a 4 base 5′ end protrusion upon cleavage (e.g. NotI). After ad-hoc synthesis, PCR amplification, and restriction-digestion, only the two most 5′ end bases of the recognition site are retained. Therefore, this series of reactions should be executed exactly when the appropriate two nucleotides are to be synthesized. For each enzyme, this is possible approximately once every 16 bases. The potential for such amplification-restriction is much greater when several complementary sets of enzyme and primer are made available, increasing the chance that a larger subset of these would allow unique cleavage.

The necessary recovery of the dissolved growing NA molecules in FIG. 5B requires the added complexity of a reversible primer-attachment, constituting a shortcoming of this embodiment. Yield and accuracy of OTP synthesis can be assayed by QPCR and deep sequencing, respectively.

According to one aspect of the technology described herein a method and apparatus is provided for the synthesis of the Green Fluorescent Protein (GFP) open reading frame (ORF) with 0.1% efficiency at 1.5 minutes per cycle with less than a 1 in a Million error-rate.

Another aspect of the technology described herein is to provide a novel method and apparatus for synthesizing a 5 Kb long expression vector with 0.01% efficiency at 1.5 minutes per cycle with a less than 1 in a Million error-rate. The vector may comprise a functional vector, including a bacterial origin of replication and selection cassette, a mammalian expression cassette, and a multiple cloning site, being rich with palindromes.

VI. Parallelization of OTP

Parallelization of OTP can be used to synthesize genes faster and more efficiently. FIG. 7A through FIG. 7D are schematic diagrams illustrating parallel OPT. FIG. 7A illustrates how parallel OTP 150 begins. First, the synthesis scheme is divided into shorter segments 152 to be synthesized in parallel by OTP 154. Interestingly, molecules that have failed to be fully synthesized by OTP 156 may act as primers during the PCR stage, shown in FIG. 7B.

FIG. 7B shows how the two consecutive segments in the primary OTP stage 152 correspond to their opposite strands at their complementary 3′ ends 158. Importantly, there is no need for custom primers. When OTP of the segments is completed, they can be annealed and subsequently amplified via PCR 160 using primers that correspond to the seed regions, Seed A and Seed B, resulting in the amplified desired NA molecule 162 and the non-magnetized fraction to be discarded 164. It should be noted that nonmagnetic beads may be used for seed A and magnetic beads for seed B, in which case the magnetized fragment would be discarded.

FIG. 7C shows how the resulting 3′ end of the amplified NA molecule 166 will have an undesired extension being complementary to the seed. However, this unwanted segment of NA can be cleaved and discarded using a restriction enzyme 168 that has a unique site 170 in the seed and cleaves at the seed's 3′ terminus, outside of the recognition sequence (e.g. BspQI). Restriction is followed by denaturation and separation, leaving only single stranded NA 172 bound to the beads. The bound single stranded NA 172 products of two cycles of parallel OTP are designed with 3′ complementarity ends for additional PCR amplifications, until the entire gene has been synthesized.

FIG. 7D shows an overview of parallel OTP. The synthesis scheme is divided into shorter segments, which are synthesized by OTP in parallel. The segments are then serially joined by cycles of PCR, restriction and separation.

Importantly, this method overcomes the two major limitations of OTP. First, if an OTP cycle takes 5 minutes, then 5,000 bases would take 25,000 minutes (17.3 days) to be synthesized sequentially. Conversely, with parallelized OTP, 5,000 bases are synthesized in less than 24 hours. Second, without amplification it is challenging to synthesize thousands of bases via OTP because of the exponential decrease. If each cycle is 0.99 efficient, then 1,000 cycles are 0.99^{1,000}=0.00004 efficient. On the other hand, if we amplify every ˜100 bases, we increase the efficiency by many orders of magnitude. Importantly, we do so without requiring custom primers and without the PCR requiring additional time. In fact, it reduces the time required considerably.

VII. Pre-Synthesis NA Sequence and Oligonucleotide Analysis

The technology described herein relies on the proper annealing of a myriad of different NA sequences. Thus, analysis of the possible annealing outcomes, given a specific set of parameters, would be highly beneficial in order to adjust the parameters and avoid the introduction of errors and reduced efficiency.

FIG. 8 is a flow diagram illustrating how an end user can analyze the potential difficulties that may occur with any given NA sequence and oligonucleotides used for OTP or parallel OTP in the corresponding array 250. First, the user selects a NA sequence to be synthesized 260. Next, the user selects analysis parameters related to the desired sequence 270. For example, the user may choose to define sub-sequences that should not be changed even if they pose a synthesis challenge (e.g. a competing annealing) vs. sub-sequences in which substitutions may be considered in order to circumvent a synthesis challenge. In particular, the user may define open reading frames along with the respective genetic code and codon usage bias in order to allow the analysis method to offer synonymous substitutions where such could circumvent a synthesis challenge. The user may also define restriction sites that should not be affected by substitutions and restriction sites that should not be created by substitutions. The user could define additional sequences that should not be created by substitutions, e.g. splicing sites and transcription factor binding sites.

The analysis may also include a parallel OTP scheme by dividing the input sequence into segments, such that any two consecutive segments correspond to opposite strands and are complementary at their 3′ end. One condition for analysis under the parallel OTP method is that alignment between any two such segments must have a melting temperature (Tm) above a predetermined threshold in order to allow specific PCR amplification in a subsequent step. The length of each segment is typically but not necessarily between 40 to 100 bases.

The analysis method should also include assignment of a seed sequence to each segment. For every seed except the most distal seeds, the seed should be chosen such that it includes a recognition site for a restriction enzyme that, after PCR amplification, should cleave uniquely at the junction between the seed and the growing chain. In particular, the recognition site should not be present in any combination of segments that are to be amplified with a primer corresponding to the seed in question. The most distal seeds may be chosen such that they contain none of the aforementioned restriction sites. The sequence of all seeds should be characterized by a high enough Tm to allow specific PCR amplification. There are two types of seeds: one with attachment chemistry to a solid surface and the other to act in solution as a primer for PCR amplification. Proximity to the solid surface may inhibit PCR amplification and subsequent restriction. Therefore, each seed to be attached will either contain a long NA sequence or some other kind of covalent linker to distance the reactive sequence from the solid surface.

For every sequence to be synthesized by OTP (whether or not it is a sub-sequence of parallel OTP 290) the analysis method would identify the series of oligonucleotides to be used for elongation of the growing-chain 280, 290. The analysis method would then analyze the identified oligos to detect cycles that would be prone to the introduction of errors and that would reduce efficiency as a result of competitive annealing 300.

If the challenge is in a sequence defined by the user to be sensitive to any substitution the analysis method would notify the user of the challenge and suggest any or some of the following: prolonged incubations for annealing and or elongation, use of more restrictive conditions, (in particular, higher temperatures), use of higher reactant concentration (e.g. oligos or polymerase), several repetitions of the same cycle (unless the problem is distal competing annealing, where repeated cycles can introduce errors).

Where the challenge is proximal competing annealing, the analysis may suggest the use of a different oligo in a preliminary annealing step. This oligo would compete with the competing annealing without competing with the desired annealing. PCR amplification of intermediate products (see FIG. 6), use of long, and custom ordered bridging oligonucleotides (least favorable) may provide solutions to all kinds of competing annealing.

If the challenge is in a sequence for which the user did not specifically prohibit substitutions, in addition to the solutions described, the analysis would reveal a substitution, or a set of substitutions, that circumvent the challenge by competing annealing. However, if the challenge is within an open reading frame, the substitution/s must be synonymous and have a minimal effect on gene expression according to the genetic code and codon usage bias provided by the user. The substitution/s should not create or destroy sequences defined by the user such as restriction sites, splicing sites and transcription factor binding sites. In addition, if the challenge is in a region of complementarity between two segments to be synthesized by OTP in parallel, then a substitution designed to solve a challenge in the synthesis of one segment must not create a challenge in the synthesis of the other. Also, the substitution must not reduce the Tm of the complementarity region beneath a predetermined threshold to allow for subsequent PCR amplification. Finally, if the sequence is part of a parallel OTP scheme, then the substitution must not create a recognition site for the restriction enzyme to be used in order to cleave off the seed after PCR amplification.

The implications of reliable, fast, and cheap NA synthesis are far-reaching. Genes may now be produced at higher rates entailing optimized codon usage, codon replacements, and radical protein redesigning. Vectors can be manufactured carrying desired combinations of regulatory elements and multiple cloning sites of choice. With new technology, entire metabolic pathways could be designed to allow cost-effective bio-production of industrial chemicals, biofuels, and drugs. Carefully-designed and synthesized libraries of variants could be optimized for subsequent directed-evolution (e.g. viral vectors and Aptamers). De novo NA synthesis is projected to play an ever increasing role in the construction of NA vaccinations and the production of attenuated pathogens for immunization.

OTP could further be used in the study and application of Xeno Nucleic Acids (XNA)—synthetic genetic polymers capable of heredity and evolution. The applications of NA synthesis in research, biotechnology, and therapeutics are complemented in recent years by cutting-edge technologies applying NA for digital-data-storage, nanoscale engineering, and robotics. Most strikingly, OTP could serve in the de novo synthesis of entire genomes of viruses and bacteria and even in the redesign of eukaryotic chromosomes.

From the discussion above it will be appreciated that the technology described herein can be embodied in various ways, including the following:

A method of synthesizing DNA by sequential addition of nucleotides to a single stranded DNA molecule (DME), the method comprising the steps of a) annealing the DME with an oligonucleotide, wherein the 3′-end of the oligonucleotide is complementary to the 3′ end of the DME and the protruding 5′-end of the oligonucleotide has the correct sequence to serve as a template for DME elongation to produce the desired DNA sequence; b) contacting the DME with a DNA polymerase in the presence of one or more deoxyribonucleotides under conditions permitting the DNA polymerase to catalyze addition of one or more deoxyribonucleotides to the 3′ end of the DME using the annealed oligonucleotide as a template; c) denaturing the DME-oligonucleotide duplex; d) optionally washing the DME to remove the oligonucleotide from the DME; and e) repeating steps b-e until the desired full-length DNA product is synthesized.

The method of any of the preceding embodiments, wherein only one nucleotide is added to the DME per cycle of elongation, wherein the 5′-most nucleotide of the oligonucleotide used in each cycle is complementary to the nucleotide to be added to the DME to produce the desired sequence of the DNA product.

The device for synthesizing DNA according to the method of any of the preceding embodiments, the device comprising an ordered array of oligonucleotides, wherein said array comprises oligonucleotides of a fixed length, said oligonucleotides collectively comprising every possible sequence permutation.

The device according to any of the preceding embodiments comprising, a) the ordered array of oligonucleotides, wherein said array comprises oligonucleotides of a fixed length, said oligonucleotides collectively comprising every possible sequence permutation, wherein said oligonucleotides are contained in a plurality of chambers comprising reagents for annealing; b) at least one elongation chamber; c) at least one denaturation chamber; d) an automated arm capable of moving between the ordered array of oligonucleotides and the elongation and denaturation chambers during each cycle of DNA polymerization; and e) a support for binding the DNA to be extended (DME), wherein said support is attached to the automated arm.

The device according to any of the preceding embodiments, wherein at least one chamber is thermoregulated.

The device according to any of the preceding embodiments, wherein the support is coated with streptavidin.

The device according to any of the preceding embodiments, wherein the support is a needle.

The device according to any of the preceding embodiments, wherein the ordered array of oligonucleotides comprises 16,384 different oligonucleotide heptamers at addressable positions in the array.

A device according to any of the preceding embodiments, comprising 16,384 different heptamers, wherein each heptamer is located in a separate chamber at a different position in the array.

A device according to any of the preceding embodiments, wherein the array comprises 256 separate chambers located at different positions in the array, wherein each chamber comprises 64 different heptamers, wherein all heptamers in the chamber have the identical nucleotide sequence at the first four nucleotide positions from the 5′ end of the heptamer and different nucleotide sequences for the remaining three nucleotides at the 3′ end of the heptamer.

The device according to any of the preceding embodiments, wherein the fixed length of the oligonucleotides in the array ranges from 6 to 21 nucleotides.

The device according to any of the preceding embodiments, wherein the fixed length is 11 nucleotides.

The device according to any of the preceding embodiments, wherein the fixed length is 7 nucleotides.

The device according to any of the preceding embodiments, comprising a single elongation chamber for addition of all four of the deoxyribonucleotides dATP, dGTP, dCTP, and dTTP for the polymerase reaction.

The device according to any of the preceding embodiments, wherein the elongation chamber is subdivided into four separate compartments each containing a different deoxyribonucleotide.

The device according to any of the preceding embodiments, wherein the device is a microfluidics device.

The device according to any of the preceding embodiments, further comprising a PCR chamber.

A method for synthesizing a DNA molecule using the device of any of the preceding embodiments, the method comprising the steps of: a) immobilizing the DNA to be extended (DME) on the support; b) moving the automated arm to the array of oligonucleotides to select an oligonucleotide for annealing to the DME, wherein the oligonucleotide selected from the array has the correct sequence to serve as a template for DME elongation; c) annealing the selected oligonucleotide to the 3′ end of the DME; d) moving the automated arm to the elongation chamber; e) contacting the DME with a DNA polymerase in the presence of one or more deoxyribonucleotides under conditions permitting the DNA polymerase to catalyze addition of one or more deoxyribonucleotides to the 3′ end of the DME using the annealed oligonucleotide as a template; f) moving the automated arm to the denaturation chamber; g) denaturing the DME-oligonucleotide duplex; h) optionally washing the DME to remove the oligonucleotide from the DME; and i) repeating steps b-h until the desired full-length DNA molecule is synthesized.

The method according to any of the preceding embodiments, wherein the fixed length of the oligonucleotides in the array ranges from 6 to 21 nucleotides.

The method according to any of the preceding embodiments, wherein the fixed length is 11 nucleotides.

The method according to any of the preceding embodiments, wherein the oligonucleotide is 7 nucleotides.

The method according to any of the preceding embodiments, wherein annealing and elongation are performed at a temperature of 25° C.

The method according to any of the preceding embodiments, wherein the oligonucleotide comprises at least one locked nucleic acid (LNA).

The method according to any of the preceding embodiments, wherein the synthesized DNA molecule is at least 1 kilobase in length.

The method according to any of the preceding embodiments, wherein the synthesized DNA molecule is at least 10 kilobases in length.

The method according to any of the preceding embodiments, wherein the error rate is no more than 1 error per 1 million bases.

The method according to any of the preceding embodiments, wherein at least 2 kilobases of DNA are synthesized in 24 hours.

The method according to any of the preceding embodiments, wherein the DME is biotinylated.

The method according to any of the preceding embodiments, wherein the biotinylated DME binds to a streptavidin substrate in the device.

The method according to any of the preceding embodiments, further comprising amplification of the DNA molecule by PCR.

The method according to any of the preceding embodiments, wherein a 5′-tailed primer is used to extend the DNA molecule during amplification.

The device according to any of the preceding embodiments comprising: a) an ordered array of oligonucleotides, wherein said array comprises 10 oligonucleotides of a fixed length, said oligonucleotides collectively comprising every possible sequence permutation, wherein said oligonucleotides are contained in a plurality of chambers comprising reagents for annealing and elongation; b) at least one chamber for denaturation; c) an automated arm capable of moving between the ordered array of oligonucleotides and the chamber for denaturation during each cycle of DNA polymerization; and d) a support for binding the DNA to be extended (DME), wherein said support is attached to the automated arm is also presented.

The device according to any of the preceding embodiments, wherein each oligonucleotide in the array comprises a blocking group at the 3′ end.

The device according to any of the preceding embodiments, wherein at least one chamber is thermoregulated.

The device according to any of the preceding embodiments, wherein the support is coated with streptavidin.

The device according to any of the preceding embodiments, wherein the support is a needle.

The device according to any of the preceding embodiments, wherein the ordered array of oligonucleotides comprises 16,384 different oligonucleotide heptamers at addressable positions in the array.

The device according to any of the preceding embodiments, comprising 16,384 different heptamers, wherein each heptamer is located in a separate chamber at a different position in the array.

The device according to any of the preceding embodiments, wherein the array comprises 256 separate chambers located at different positions in the array, wherein each chamber comprises 64 different heptamers, wherein all heptamers in the chamber have the identical nucleotide sequence at the first four nucleotide positions from the 5′ end of the heptamer and different nucleotide sequences for the remaining three nucleotides at the 3′ end of the heptamer.

The device according to any of the preceding embodiments, wherein the fixed length of the oligonucleotides in the array ranges from 6 to 21 nucleotides.

The device according to any of the preceding embodiments, wherein the fixed length is 11 nucleotides.

The device according to any of the preceding embodiments, wherein the fixed length is 7 nucleotides.

The device according to any of the preceding embodiments, wherein the device is a microfluidics device.

The device according to any of the preceding embodiments, further comprising a PCR chamber.

A method for synthesizing a DNA molecule using the device according to any of the preceding embodiments, the method comprising the steps of: a) immobilizing DNA to be extended (DME) on the support; b) moving the automated arm to the array of oligonucleotides to select an 25 oligonucleotide for annealing to the DME, wherein the oligonucleotide selected from the array has the correct sequence to serve as a template for DME elongation; c) annealing the selected oligonucleotide to the 3′ end of the DME; d) contacting the DME with a DNA polymerase in the presence of one or more deoxyribonucleotides under conditions permitting the DNA polymerase to catalyze addition of one or more deoxyribonucleotides to the 3′ end of the DME using the annealed oligonucleotide as a template; e) moving the automated arm to the denaturation chamber; f) denaturing the DME-oligonucleotide duplex; g) optionally washing the DME to remove the oligonucleotide from the DME; and h) repeating steps b-g until the desired full-length DNA molecule is synthesized.

The method according to any of the preceding embodiments, wherein the oligonucleotide comprises a blocking group at the 3′ end such that the oligonucleotide serves as a template and not as a primer during DNA elongation.

The method according to any of the preceding embodiments, wherein the fixed length of the oligonucleotides in the array ranges from 6 to 21 nucleotides.

The method according to any of the preceding embodiments, wherein the fixed length is 11 nucleotides.

The method according to any of the preceding embodiments, wherein the oligonucleotide is 7 nucleotides.

The method according to any of the preceding embodiments, wherein annealing and elongation are performed at a temperature of 25° C.

The method according to any of the preceding embodiments, wherein the oligonucleotide comprises at least one locked nucleic acid (LNA).

The method according to any of the preceding embodiments, wherein the synthesized DNA molecule is at least 1 kilobase in length.

The method according to any of the preceding embodiments, wherein the synthesized DNA molecule is at least 10 kilobases in length.

The method according to any of the preceding embodiments, wherein the error rate is no more than 1 error per 1 million bases.

The method according to any of the preceding embodiments, wherein at least 2 kilobases of DNA are synthesized in 24 hours.

The method according to any of the preceding embodiments, wherein the DME is biotinylated.

The method according to any of the preceding embodiments, wherein the biotinylated DME binds to a streptavidin substrate in the device.

The method according to any of the preceding embodiments, further comprising amplification of the DNA molecule by PCR.

The method according to any of the preceding embodiments, wherein a 5′-tailed primer is used to extend the DNA molecule during amplification.

The device according to any of the preceding embodiments comprising: a) an ordered array of oligonucleotides, wherein said array comprises oligonucleotides of a fixed length, said oligonucleotides collectively comprising every possible sequence permutation, wherein said oligonucleotides are contained in a plurality of chambers comprising reagents for annealing, elongation, and denaturation; b) an automated arm capable of moving among the plurality of chambers of the ordered array of oligonucleotides to select an oligonucleotide during each cycle of DNA polymerization; and c) a support for binding the DNA to be extended (DME), wherein said support is attached to the automated arm.

The device according to any of the preceding embodiments, wherein each oligonucleotide in the array comprises a blocking group at the 3′ end.

The device according to any of the preceding embodiments, wherein at least one chamber is thermoregulated.

The device according to any of the preceding embodiments, wherein the substrate is streptavidin.

The device according to any of the preceding embodiments, wherein the ordered array of oligonucleotides 5 comprises 16,384 different oligonucleotide heptamers at addressable positions in the array.

The device according to any of the preceding embodiments, comprising 16,384 different heptamers, wherein each heptamer is located in a separate chamber at a different position in the array.

The device according to any of the preceding embodiments, wherein the array comprises 256 separate chambers located at different positions in the array, wherein each chamber comprises 64 different heptamers, wherein all heptamers in the chamber have the identical nucleotide sequence at the first four nucleotide positions from the 5′ end of the heptamer and different nucleotide sequences for the remaining three nucleotides at the 3′ end of the heptamer.

The device according to any of the preceding embodiments, wherein the fixed length of the oligonucleotides in the array ranges from 6 to 21 nucleotides.

The device according to any of the preceding embodiments, wherein the fixed length is 11 nucleotides.

The device according to any of the preceding embodiments, wherein the fixed length is 7 nucleotides.

The device according to any of the preceding embodiments, wherein the device is a microfluidics device.

The device according to any of the preceding embodiments, further comprising a PCR chamber.

A method for synthesizing a DNA molecule using the device according to any of the preceding embodiments, the method comprising the steps of: a) immobilizing the DNA to be extended (DME) on the support; b) moving the automated arm to the array of oligonucleotides to select an oligonucleotide for annealing to the DME, wherein the oligonucleotide selected from the array has the correct sequence to serve as a template for DME elongation; c) annealing the selected oligonucleotide to the 3′ end of the DME; d) contacting the DME with a DNA polymerase in the presence of one or more deoxyribonucleotides under conditions permitting the DNA polymerase to catalyze addition of one or more deoxyribonucleotides to the 3′ end of the DME using the annealed oligonucleotide as a template; e) denaturing the DME-oligonucleotide duplex; f) optionally washing the DME to remove the oligonucleotide; and g) repeating steps b-f until the desired full-length DNA molecule is synthesized.

The method according to any of the preceding embodiments, wherein the oligonucleotide comprises a blocking group at the 3′ end such that the oligonucleotide serves as a template and not as a primer during DNA elongation.

The method according to any of the preceding embodiments, wherein the fixed length of the oligonucleotides in the array ranges from 6 to 21 nucleotides.

The method according to any of the preceding embodiments, wherein the fixed length is 11 nucleotides.

The method according to any of the preceding embodiments, wherein the oligonucleotide is 7 nucleotides.

The method according to any of the preceding embodiments, wherein annealing and elongation are performed at a temperature of 25° C.

The method according to any of the preceding embodiments, wherein the oligonucleotide comprises at least one locked nucleic acid (LNA).

The method according to any of the preceding embodiments, wherein the DNA molecule is at least 1 kilobase in length.

The method according to any of the preceding embodiments, wherein the DNA molecule is at least 10 kilobases in length.

The method according to any of the preceding embodiments, wherein the error rate is no more than 1 error per 1 million bases.

The method according to any of the preceding embodiments, wherein at least 2 kilobases of DNA are synthesized in 24 hours.

The method according to any of the preceding embodiments, wherein the DME is biotinylated.

The method according to any of the preceding embodiments, wherein the biotinylated DME binds to a streptavidin substrate in the device.

The method according to any of the preceding embodiments, further comprising amplification of the DNA molecule by PCR.

The method according to any of the preceding embodiments, wherein a 5′-tailed primer is used to extend the DNA molecule during amplification.

The device according to any of the preceding embodiments comprising: a) a chamber for annealing, elongation and denaturation, wherein said chamber comprises a substrate for binding the DNA to be extended (DME); b) the ordered array of oligonucleotides, wherein said array comprises oligonucleotides of a fixed length, said oligonucleotides collectively comprising every possible sequence permutation; and c) an automated arm capable of moving to the ordered array of oligonucleotides and delivering a selected oligonucleotide to the chamber during each cycle of DNA polymerization.

The device according to any of the preceding embodiments, wherein each oligonucleotide 5 in the array comprises a blocking group at the 3′ end.

The device according to any of the preceding embodiments, wherein at least one chamber is thermoregulated.

The device according to any of the preceding embodiments, wherein the substrate is streptavidin.

The device according to any of the preceding embodiments, wherein the ordered array of oligonucleotides comprises 16,384 different oligonucleotide heptamers at addressable positions in the array.

The device according to any of the preceding embodiments, comprising 16,384 different heptamers, wherein each heptamer is located in a separate chamber at a different position in the array.

The device according to any of the preceding embodiments, wherein the array comprises 256 separate chambers located at different positions in the array, wherein each chamber comprises 64 different heptamers, wherein all heptamers in the chamber have the identical nucleotide sequence at the first four nucleotide positions from the 5′ end of the heptamer and different nucleotide sequences for the remaining three nucleotides at the 3′ end of the heptamer.

The device according to any of the preceding embodiments, wherein the fixed length of the oligonucleotides in the array ranges from 6 to 21 nucleotides.

The device according to any of the preceding embodiments, wherein the fixed length is 11 nucleotides.

The device according to any of the preceding embodiments, wherein the fixed length is 7 nucleotides.

The device according to any of the preceding embodiments, wherein the device is a microfluidics device.

The device according to any of the preceding embodiments, further comprising a PCR chamber.

A method for synthesizing a DNA molecule using the device according to any of the preceding embodiments, the method comprising the steps of: a) immobilizing the DNA to be extended (DME) on the substrate of the chamber; b) moving the automated arm to the array of oligonucleotides to select an oligonucleotide for transfer to the chamber, wherein the oligonucleotide selected from the array has the correct sequence to serve as a template for DME elongation; c) annealing the selected oligonucleotide to the 3′ end of the DME; d) contacting the DME with a DNA polymerase in the presence of one or more deoxyribonucleotides under conditions permitting the DNA polymerase to catalyze addition of one or more deoxyribonucleotides to the 3′ end of the DME using the annealed oligonucleotide as a template; e) denaturing the DME-oligonucleotide duplex; f) optionally washing the DME to remove the oligonucleotide; and g) repeating steps b-f until the desired full-length DNA molecule is synthesized.

The method according to any of the preceding embodiments, wherein the oligonucleotide comprises a blocking group at the 3′ end such that the oligonucleotide serves as a template and not as a primer during DNA elongation.

The method according to any of the preceding embodiments, wherein the fixed length of the oligonucleotides in the array ranges from 6 to 21 nucleotides.

The method according to any of the preceding embodiments, wherein the fixed length is 11 nucleotides.

The method according to any of the preceding embodiments, wherein the oligonucleotide is 7 nucleotides.

The method according to any of the preceding embodiments, wherein annealing and elongation are performed at a temperature of 25° C.

The method according to any of the preceding embodiments, wherein the oligonucleotide comprises at least one locked nucleic acid (LNA).

The method according to any of the preceding embodiments, wherein the DNA molecule is at least 1 kilobase in length.

The method according to any of the preceding embodiments, wherein the DNA molecule is at least 10 kilobases in length.

The method according to any of the preceding embodiments, wherein the error rate is no more than 1 error per 1 million bases.

The method according to any of the preceding embodiments, wherein at least 2 kilobases of DNA are synthesized in 24 hours.

The method according to any of the preceding embodiments, wherein the DME is biotinylated.

The method according to any of the preceding embodiments, wherein the biotinylated DME binds to a streptavidin substrate in the device.

The method according to any of the preceding embodiments, further comprising amplification of the DNA molecule by PCR.

The method according to any of the preceding embodiments, wherein a 5′-tailed primer is used to extend the DNA molecule during amplification.

A method of synthesizing nucleic acid (NA), the method comprising: (a) providing a single stranded NA molecule growing-chain, said growing-chain having a 3′ end; (b) annealing the growing-chain to an oligonucleotide, said oligonucleotide having a 3′ end and a protruding 5′ end, wherein the 3′ end of the oligonucleotide is complementary to the 3′ end of the growing-chain and wherein the protruding 5′ end of the oligonucleotide has a correct sequence to serve as a template for the growing-chain to produce a NA product; (c) contacting the growing-chain with a polymerase in the presence of one or more nucleotide triphosphates under conditions permitting the polymerase to catalyze addition of one or more nucleotides to the 3′ end of the growing-chain using the oligonucleotide as a template; (d) denaturing the annealed growing-chain and oligonucleotide; and (e) repeating steps (b) through (d) until the NA product of desired length is synthesized.

The method according to any of the preceding embodiments, wherein said steps (a) through (d) comprise one cycle of elongation, and wherein only one nucleotide triphosphate is added to the growing-chain per cycle of elongation and wherein the 5′-most nucleotide of the oligonucleotide selected in each cycle is complementary to the nucleotide triphosphate to be added to the growing-chain to produce the desired sequence of the NA product.

The method according to any of the preceding embodiments: wherein the oligonucleotide is selected from an array of oligonucleotides; wherein said array comprises a plurality of oligonucleotides of a fixed length; and wherein the oligonucleotides collectively comprise every possible sequence permutation.

The method according to any of the preceding embodiments, further comprising: grouping said oligonucleotides in said array; wherein the oligonucleotides in said groups have an identical 5′ end.

The method according to any of the preceding embodiments, further comprising: binding the growing-chain to a support immobilized on the inside of a reservoir; and using an automated arm for: contacting the immobilized growing-chain with the selected oligonucleotide; contacting the immobilized growing chain with a denaturation chamber.

The method according to any of the preceding embodiments, further comprising: binding the growing-chain to a support attached to a distal end of an automated arm; and using an automated arm for: contacting the immobilized growing-chain with the selected oligonucleotide; contacting the immobilized growing chain with a denaturing solution; and contacting the immobilized growing chain with a neutralizing solution.

The method according to any of the preceding embodiments, further comprising: binding the oligonucleotides to the array, wherein the oligonucleotides are bound to the inside of a reservoir; and transferring a solution comprising the growing-chain, polymerase and nucleotide triphosphates to the selected oligonucleotide in the array for annealing and polymerization of the growing-chain.

The method according to any of the preceding embodiments wherein the growing-chain and the oligonucleotides are analyzed using the method comprising: selecting parameters according to characteristics of the growing-chain; identifying a series of oligonucleotides; detecting one or more cycles of synthesis that are prone to introductions of errors and reduced efficiency; and changing a condition of synthesis to avoid the errors and reduced efficiency.

The method according to any of the preceding embodiments, further comprising washing the growing-chain to further remove one or more of the oligonucleotide, polymerase, and nucleotide triphosphates from the growing-chain after denaturing the annealed growing-chain and oligonucleotide.

The method according to any of the preceding embodiments, wherein the NA is a modified NA.

The method according to any of the preceding embodiments, wherein the oligonucleotides comprise any one or more of locked nucleic acids, universal nucleotides, and xeno nucleic acids.

The method according to any of the preceding embodiments; wherein the support comprises a magnetic bead; wherein the magnetic bead is immobilized using an external magnet; and wherein the oligonucleotides, polymerase and nucleotide triphosphates are added to the beads.

The method according to any of the preceding embodiments, wherein the growing-chain is bound by an attachment chemistry selected from the group consisting of streptavidin-biotin, alkyne-azide, and amine-NHS.

The method according to any of the preceding embodiments: wherein the NA molecule is synthesized at 1.5 min per cycle of synthesis; and wherein the error rate is no more than 1 error per 1 million bases.

The method according to any of the preceding embodiments, wherein the fixed length of the oligonucleotides in the array ranges from 6 to 21 nucleotides.

The method according to any of the preceding embodiments, wherein the fixed length is 11 nucleotides.

The method according to any of the preceding embodiments, wherein the fixed length is 7 nucleotides.

The method according to any of the preceding embodiments, further comprising amplification of an intermediate NA molecule by PCR.

The method according to any of the preceding embodiments, further comprising amplification of the NA product by PCR.

The method according to any of the preceding embodiments, wherein said polymerase is bound to a support.

An apparatus for synthesizing nucleic acid (NA), the apparatus comprising: (a) an array of oligonucleotides, wherein said array comprises a plurality of oligonucleotides of a fixed length, and wherein the oligonucleotides collectively comprise every possible sequence permutation; (b) a reaction chamber, wherein an oligonucleotide is contacted with a nucleic acid molecule growing-chain, said growing-chain having a 3′ end, said oligonucleotide having a 3′ end and a protruding 5′ end; (c) wherein the 3′ end of the oligonucleotide is complementary to the 3′ end of the growing-chain; (d) wherein the protruding 5′ end of the oligonucleotide has the correct sequence to serve as a template for the growing-chain to produce a NA product; and (e) wherein the oligonucleotide and growing-chain are in the presence of one or more nucleotides under conditions permitting the polymerase to catalyze addition of one or more nucleotide triphosphates to the 3′ end of the growing-chain using the annealed oligonucleotide as a template; (f) a denaturing chamber; and (g) an automated arm configured for moving between the array of oligonucleotides, the elongation chamber, the denaturing chamber, and the reservoir of neutralization solution during a cycle of nucleic acid polymerization.

The apparatus according to any of the preceding embodiments, further comprising a washing chamber.

The apparatus according to any of the preceding embodiments, wherein the growing-chain is bound to a magnetic bead; and wherein the magnetic bead is immobilized on the bottom of the elongation chamber.

The apparatus according to any of the preceding embodiments: wherein the growing-chain is bound to magnetic bead; wherein the magnetic bead is immobilized on a magnetized needle; and wherein the needle is attached to a distal end of the automated arm.

The apparatus according to any of the preceding embodiments, wherein the growing chain is bound to the magnetic bead by an attachment chemistry selected from the group consisting of streptavidin-biotin, alkyne-azide, and amine-NHS.

The apparatus according to any of the preceding embodiments, wherein the oligonucleotides are bound to said reaction chamber.

The apparatus according to any of the preceding embodiments, wherein one or more of the chambers is thermoregulated.

The apparatus according to any of the preceding embodiments: wherein the elongation chamber is subdivided into separate chambers; and wherein each contains a different nucleotide triphosphate.

The apparatus according to any of the preceding embodiments, further comprising a PCR chamber.

The apparatus according to any of the preceding embodiments, wherein the fixed length of the oligonucleotides in the array ranges from 6 to 21 nucleotides.

The apparatus according to any of the preceding embodiments, wherein the fixed length is 11 nucleotides.

The apparatus according to any of the preceding embodiments, wherein the fixed length is 7 nucleotides.

A method of synthesizing nucleic acid (NA), the method comprising: (a) selecting a NA sequence, wherein the NA comprises two strands, each with a 5′ end; (b) dividing said NA sequence into a plurality of partial sequences, wherein said plurality of partial sequences comprises a partial sequence corresponding to the 5′ end of each of said two strands of the NA sequence, wherein each set of two consecutive partial sequences correspond to an opposite strand of said NA, wherein each set of two consecutive partial sequences are partially complementary to each other, and wherein an alignment of said sets of two consecutive partial sequences has a melting temperature that permits PCR amplification; (c) selecting two consecutive partial sequences comprising a first partial sequence and a second partial sequence, wherein said first partial sequence and said second partial sequence are complementarity at 3′ ends; (d) providing a first seed NA for the synthesis of said first partial sequence and a second seed NA for the synthesis of said second partial sequence; (e) annealing said first seed NA to an oligonucleotide, said oligonucleotide having a 3′ end, wherein said annealing creates a protruding 5′ end, wherein the 3′ end of said oligonucleotide is complementary to the 3′ end of said first seed NA, wherein said protruding 5′ end of said oligonucleotide has a correct sequence to serve as a template for the addition of nucleotides, wherein said oligonucleotide is selected from an array of oligonucleotides, wherein said array comprises a plurality of oligonucleotides of a fixed length, and wherein the oligonucleotides collectively comprise every possible sequence permutation; (f) contacting said first seed NA with a polymerase in the presence of one or more nucleotide triphosphates under conditions permitting the polymerase to catalyze addition of one or more nucleotides to the 3′ end of the growing-chain using the oligonucleotide as a template; (g) denaturing the annealed seed NA and oligonucleotide; (h) repeating steps (e) through (g) until said first partial NA is synthesized; (i) repeating steps (e) through (h) using said second seed NA to synthesize a second partial NA; (j) annealing said complimentary 3′ end of said first partial NA to said complimentary 3′ end of said second partial NA; (k) extending said first and second partial NAs by polymerase; (l) denaturing said first and second NAs; (m) amplifying said first and second partial NAs by PCR, wherein said first and second seed sequences act as primers for said PCR; (n) removing said second seed sequences using a restriction enzyme with a corresponding recognition site in said second seed sequence; (o) repeating steps (c) through (n) to produce a plurality of partial NAs; (p) selecting a third partial NA and a fourth partial NA from said plurality of partial NAs, wherein said third partial sequence has a 3′ end complementary to a 3′ end of said fourth partial sequence; and (q) repeating steps (j) through (p) to produce subsequent pluralities of partial NAs until said selected NA sequence is synthesized.

The method according to any of the preceding embodiments, wherein said first and second seed sequences are bound to a support.

Embodiments of the technology described herein may be described with reference to flowchart illustrations of methods and systems according to embodiments of the technology described herein, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic.

As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for synthesizing nucleic acid (NA), the apparatus comprising:
(a) an array of oligonucleotides, wherein said array comprises a plurality of oligonucleotides of a fixed length, and wherein the oligonucleotides collectively comprise every possible sequence permutation;
(b) a reaction chamber, wherein an oligonucleotide is contacted with a nucleic acid molecule growing-chain, said growing-chain having a 3′ end, said oligonucleotide having a 3′ end and a protruding 5′ end;
(c) wherein the 3′ end of the oligonucleotide is complementary to the 3′ end of the growing-chain;
(d) wherein the protruding 5′ end of the oligonucleotide has the correct sequence to serve as a template for the growing-chain to produce a NA product; and
(e) wherein the oligonucleotide and growing-chain are in the presence of one or more nucleotides under conditions permitting the polymerase to catalyze addition of one or more nucleotide triphosphates to the 3′ end of the growing-chain using the annealed oligonucleotide as a template;
(f) a denaturing chamber; and
(g) an automated arm configured for moving between the array of oligonucleotides, the elongation chamber, the denaturing chamber, and the reservoir of neutralization solution during a cycle of nucleic acid polymerization.

2. The apparatus of claim 1:
wherein the growing-chain is bound to a magnetic bead; and
wherein the magnetic bead is immobilized on the bottom of the elongation chamber.

3. The apparatus of claim 2, wherein the growing chain is bound to the magnetic bead by an attachment chemistry selected from the group consisting of streptavidin-biotin, alkyne-azide, and amine-NHS.

4. The apparatus of claim 1:
wherein the growing-chain is bound to magnetic bead;
wherein the magnetic bead is immobilized on a magnetized needle; and
wherein the needle is attached to a distal end of the automated arm.

5. The apparatus of claim 4, wherein the growing chain is bound to the magnetic bead by an attachment chemistry selected from the group consisting of streptavidin-biotin, alkyne-azide, and amine-NHS.

6. The apparatus of claim 1, wherein the oligonucleotides are bound to said reaction chamber.

7. The apparatus of claim 1, wherein one or more of the chambers is thermoregulated.

8. The apparatus of claim 1:
wherein the elongation chamber is subdivided into separate chambers; and
wherein each contains a different nucleotide triphosphate.

9. The apparatus of claim 1, further comprising a PCR chamber.

10. The apparatus of claim 1, wherein the fixed length of the oligonucleotides in the array ranges from 6 to 21 nucleotides.

11. The apparatus of claim 1, wherein the fixed length is 11 nucleotides.

12. The apparatus of claim 1, wherein the fixed length is 7 nucleotides.

13. An apparatus for synthesizing nucleic acid (NA), the apparatus comprising:
(a) an array of oligonucleotides, wherein said array comprises a plurality of oligonucleotides of a fixed length, and wherein the oligonucleotides collectively comprise every possible sequence permutation;
(b) a reaction chamber, wherein an oligonucleotide is contacted with a nucleic acid molecule growing-chain, said growing-chain having a 3′ end, said oligonucleotide having a 3′ end and a protruding 5′ end;
(c) wherein the 3′ end of the oligonucleotide is complementary to the 3′ end of the growing-chain;
(d) wherein the protruding 5′ end of the oligonucleotide has the correct sequence to serve as a template for the growing-chain to produce a NA product; and
(e) wherein the oligonucleotide and growing-chain are in the presence of one or more nucleotides under conditions permitting the polymerase to catalyze addition of one or more nucleotide triphosphates to the 3′ end of the growing-chain using the annealed oligonucleotide as a template;
(f) a denaturing chamber;
(g) an automated arm configured for moving between the array of oligonucleotides, the elongation chamber, the denaturing chamber, and the reservoir of neutralization solution during a cycle of nucleic acid polymerization; and
(h) a washing chamber.

14. The apparatus of claim 13:
wherein the growing-chain is bound to a magnetic bead; and
wherein the magnetic bead is immobilized on the bottom of the elongation chamber.

15. The apparatus of claim 14, wherein the growing chain is bound to the magnetic bead by an attachment chemistry selected from the group consisting of streptavidin-biotin, alkyne-azide, and amine-NHS.

16. The apparatus of claim 13:
wherein the growing-chain is bound to magnetic bead;
wherein the magnetic bead is immobilized on a magnetized needle; and
wherein the needle is attached to a distal end of the automated arm.

17. The apparatus of claim 16, wherein the growing chain is bound to the magnetic bead by an attachment chemistry selected from the group consisting of streptavidin-biotin, alkyne-azide, and amine-NHS.

18. The apparatus of claim 13, wherein the oligonucleotides are bound to said reaction chamber.

19. The apparatus of claim 13, wherein one or more of the chambers is thermoregulated.

20. The apparatus of claim 13:
wherein the elongation chamber is subdivided into separate chambers; and
wherein each contains a different nucleotide triphosphate.

21. The apparatus of claim 13, further comprising a PCR chamber.

22. The apparatus of claim 13, wherein the fixed length of the oligonucleotides in the array ranges from 6 to 21 nucleotides.

23. The apparatus of claim 13, wherein the fixed length is 11 nucleotides.

24. The apparatus of claim 13, wherein the fixed length is 7 nucleotides.
